(19) United States
(12) Patent Application Publication
(10) Pub. No.: US 2006/0170207 A1
(43) Pub. Date: Aug. 3, 2006

(54) Greeting card with reflector for reading mirror image indicia

(76) Inventor: Donald R. Kracke, Lake Arrowhead, CA (US)

Correspondence Address: KELLY LOWRY & KELLEY, LLP, 6320 CANOGA AVENUE, SUITE 1650, WOODLAND HILLS, CA, 91367, US

(21) Appl. No.: 11/050,877

(22) Filed: Feb. 3, 2005

(51) Int. Cl. B42D 15/00

(52) U.S. Cl. 283/106

(57) ABSTRACT

A greeting card includes a planar substrate divided generally into first and second halves by a fold disposed therebetween. Mirror-image alpha-numeric indicia are disposed on the first half of the substrate and a reflective foil sheet is disposed on the second half of the substrate. The alpha-numeric indicia is right-readable on the reflective foil sheet when at least one of the first and second halves of the substrate is pivoted along the fold.

### BACKGROUND OF THE INVENTION

This invention relates generally to greeting cards. More particularly, the present invention relates to a greeting card with a reflector for reading mirror image indicia.

There is a great need for greeting cards that provide excitement to both those giving the cards and those receiving the cards. Greeting cards are generally known in the art and typically comprise a rectangle of material, such as paper, folded in half to create an exterior and interior. There is usually alpha-numeric indicia on both the interior and exterior of the card. For example, U.S. Pat. No. 3,834,051 discloses an anamorphic greeting card with a reflective surface for displaying a printed image that is distorted. However, this card requires the use of several panels and a pop-up device in order to function properly. In another example, U.S. Pat. No. 4,989,355 discloses a display card with a reflective surface. However, the reflective surface is used for creating the illusion of a three-dimensional image and requires the use of a hinge device connecting two panels in order to function properly.

Accordingly, there is a need for a greeting card that allows a user to view alpha-numeric indicia. There is a further need for a greeting card capable of allowing a user to view mirror-image alpha-numeric indicia. There is a need for a greeting card employing a reflective surface to deliver an alpha-numeric message. There is a further need for a greeting card having a reflective surface into which an image is incorporated. There is also a need for a greeting card that provides a decorative surface upon which the alpha-numeric message can be displayed. There is an additional need for a greeting card of simple design that is economical and easy to manufacture. The present invention fulfills these needs and provides other related advantages.

### SUMMARY OF THE INVENTION

The present invention provides a greeting card wherein two facing surfaces of the card cooperatively interact to provide a readable message. In this regard, one of the facing pages has a reflective surface. The facing page includes script or other indicia which is generally unreadable when directly viewed, but when viewed off of the reflective surface, includes a message of interest. The present invention provides a greeting card that allows a user to view alpha-numeric indicia, especially allowing a user to view mirror-image alpha-numeric indicia. The greeting card of the present invention also provides a decorative surface upon which the alpha-numeric message can be displayed as well as incorporating images or decorative embellishments.

A greeting card embodying the present invention includes a planar substrate divided generally into first and second halves by a fold disposed therebetween. Mirror-image alpha-numeric indicia are disposed on the first half of the substrate and a reflective foil sheet is disposed on the second half of the substrate. The alpha-numeric indicia is right-readable on the reflective foil sheet when at least one of the first and second halves of the substrate is pivoted along the fold.

The substrate includes a first side, a second side, and right-readable alpha-numeric indicia disposed on one of the first and second halves of the substrate on an opposite side of the substrate from the mirror-image alpha-numeric indicia. The substrate is made of a heavy bond paper.

The right-readable alpha-numeric indicia is defined against a colored background.

The surface of the reflective foil sheet may include various decorative embellishments and/or adornments including, but not limited to, decorative etchings, graphical indicia or the like. These adornments may be formed on, disposed on or attached to the surface of the reflective foil sheet. The reflective foil sheet may also include an image incorporated onto a surface of the sheet.

The reflective foil sheet may define a border on the second half of the substrate or the greeting card may include a border surrounding the foil sheet where the border defines a pocket within which the foil sheet is held.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the invention. In such drawings:

FIG. 1 is a front perspective view of a greeting card embodying the present invention that shows the cover of the greeting card;

FIG. 2 is a front perspective view of the greeting card of FIG. 1 that shows the interior of the card; and

FIG. 3 is a front perspective view of the greeting card of FIG. 1 showing mirror image alpha-numeric text reflected in the mirrored surface of the greeting card;

FIG. 4 is a front view of the interior of another greeting card embodying the present invention;

FIG. 5 is a front perspective view of the greeting card of FIG. 4 showing mirror image alpha-numeric text reflected in the mirrored surface of the greeting card;

FIG. 6 is a front view of the interior of an additional greeting card embodying the present invention;

FIG. 7 is a front perspective view of the greeting card of FIG. 6 showing mirror image alpha-numeric text reflected in the mirrored surface of the greeting card;

FIG. 8 is a front view of the interior of another greeting card embodying the present invention;

FIG. 9 is a front view of the greeting card of FIG. 8;

FIG. 10 is a front perspective view of the greeting card of FIG. 4 showing mirror image alpha-numeric text reflected in the mirrored surface of the greeting card.

### DETAILED DESCRIPTION OF THE PREFERRED EMBODIMENTS

A greeting card is illustrated and described that provides excitement to both those giving the cards and those receiving the cards. The greeting card is usable in any situation where someone wishes to give a card in which the message in delivered in an unusual and interesting manner.

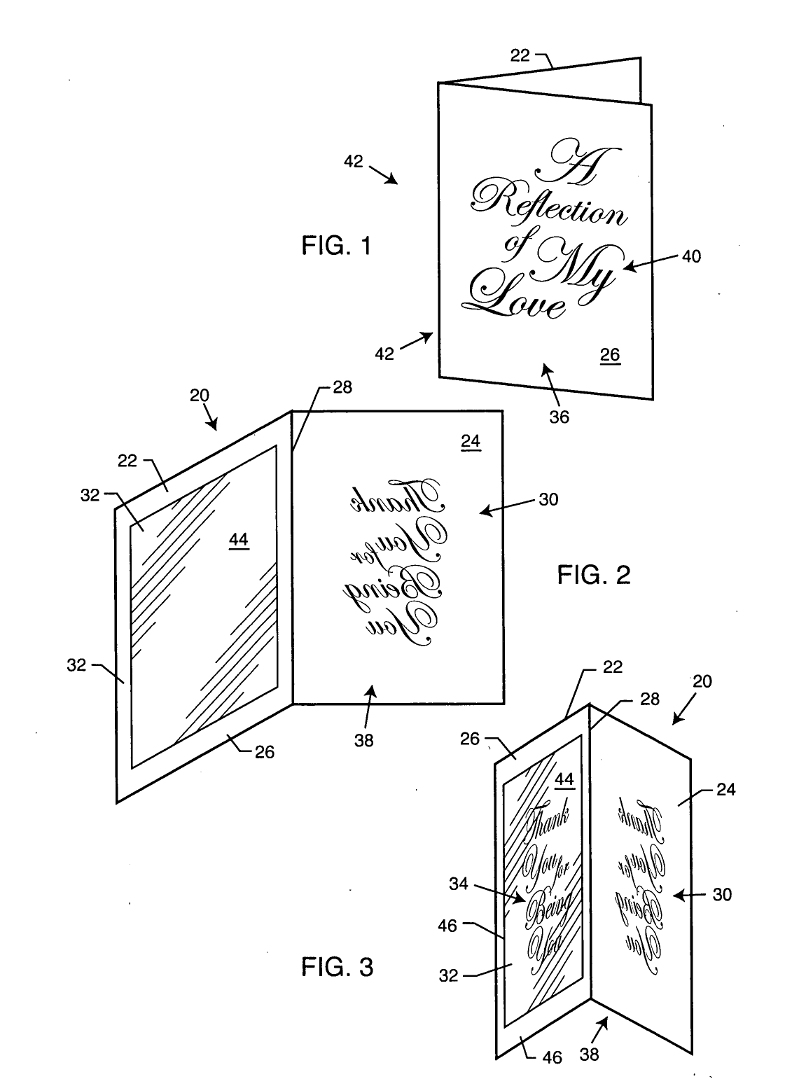

As shown in the drawings for purposes of illustration, the present invention resides in a greeting card with a reflector for reading mirror image indicia. With reference to FIGS. 1-3, a greeting card 20 includes a planar substrate 22 divided generally into first and second halves 24, 26 by a fold 28 disposed therebetween. Mirror-image alpha-numeric indicia 30 are disposed on the first half 24 of the substrate 22 and a reflective foil sheet 32 is disposed on the second half 26 of the substrate 22. The reflection 34 of the mirror-image alpha-numeric indicia 30 appears as right-readable alpha-numeric indicia on the foil sheet 32 when at least one of the first and second halves 24, 26 of the substrate 22 is pivoted along the fold 28.

The substrate 22 includes a first side 36, a second side 38, and right-readable alpha-numeric indicia 40 disposed on one of the first and second halves 24, 26 of the substrate 22 on an opposite side of the substrate 22 from the mirror-image alpha-numeric indicia 30. As seen in FIGS. 1-3, the second half 26 of the first side 36 of the substrate 22 serves as front cover 42 of the card 20 while the first half 24 of the first side 36 of the substrate serves as a back cover (not shown) of the card 20. The first and second halves 24, 26 of the second side 38 of the card 20 serves as the interior of the card 20. The right-readable alpha-numeric indicia 40 is on the front cover 42 of the card 20. Alternatively, graphical indicia, images, decorative embellishments, mirror-image alpha-numeric indicia and the like may also be placed on the front cover 42.

The substrate 22 is made of a heavy bond paper. The paper may be recycled or non-recycled. Alternatively, the substrate 22 may be made of an imprintable plastic, MYLAR, cardboard or the like. The surface of the first and second sides 36, 38 of the substrate 22 may have various appearances including, without limitation, flat, textured, glossy, dull or the like. The surface of the card 20 should be imprintable so as to allow a user to be able to write on the card 20 in order to create a personalized message to the receiver of the card. The sides 36, 38 may have one or more colors including, without limitation, white, red, blue, yellow or any combination of color thereof. In this manner, the mirror-image 30 and/or the right-readable 40 alpha-numeric indicia are defined against a colored background. The alpha-numeric indicia 30, 40 may be printed on the card 20 in any conventional manner and may be printed in one or more colors including, without limitation, white, red, blue, yellow or any combination of color thereof. Each number or alphabet letter of the indicia 30, 40 may include a border of a different color than the main body of the number of alphabet letter so that the alpha-numeric indicia 30, 40 may be defined against the background of the sides 36, 38 of the card 20 even if the alpha-numeric indicia 30, 40 and the sides 36, 38 of the card 20 are the same color.

A surface 44 of the reflective foil sheet 32 may be polished to various degrees but, at a minimum, must be sufficiently polished so as to allow a user to be able to read the reflection 34 of the mirror-image alpha-numeric indica 30 that appears as right-readable alpha-numeric indicia. The foil sheet 32 may be made of various materials including, but not limited to, metal (aluminum, tin, copper), metallized paper, paper covered with a reflective MYLAR layer or the like.

The reflective foil sheet 32 defines a border 46 on second half 26 of the second side 38 the substrate 22. Although not illustrated, the border 46 surrounding the sheet 32 may includes various embellishments (not shown) such as graphical indicia, decorative etchings, ribbons, bows, printing or the like.

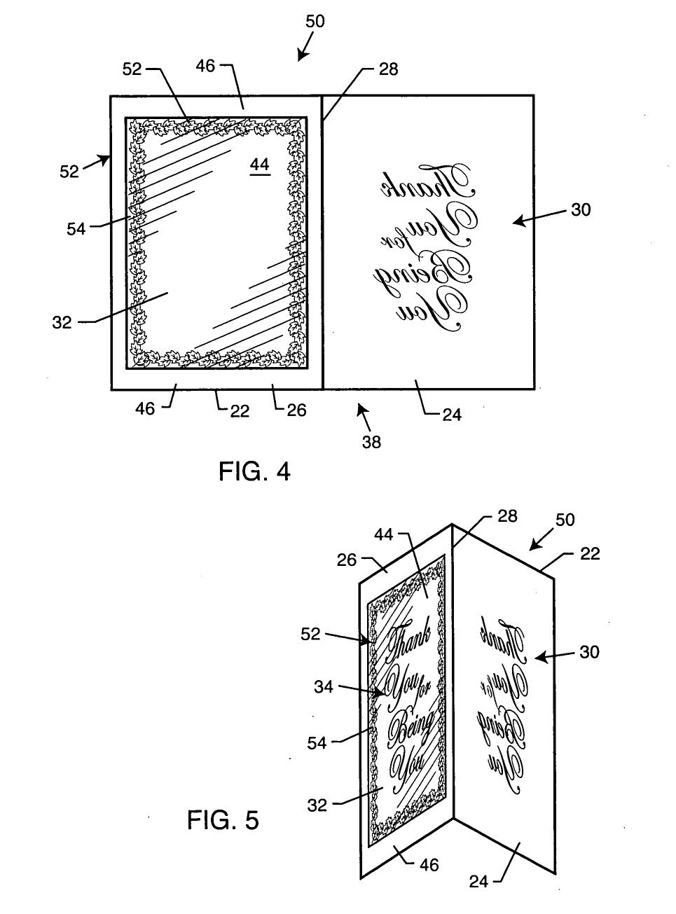

As seen in FIGS. 4 and 5, an alternative embodiment of a greeting card 50 is shown that is similar to card 20 except that the surface 44 of the reflective foil sheet 32 also has various adornments, embellishments and/or decorations 52 including, but not limited to, decorative etchings 54, graphical indicia (not shown) or the like. These adornments 52 may be formed on, disposed on or attached to the surface of the reflective foil sheet 32 by various conventional means. As outlined above, although not illustrated, the border 46 surrounding the sheet 32 may includes various embellishments (not shown) such as graphical indicia, decorative etchings, ribbons, bows, printing or the like.

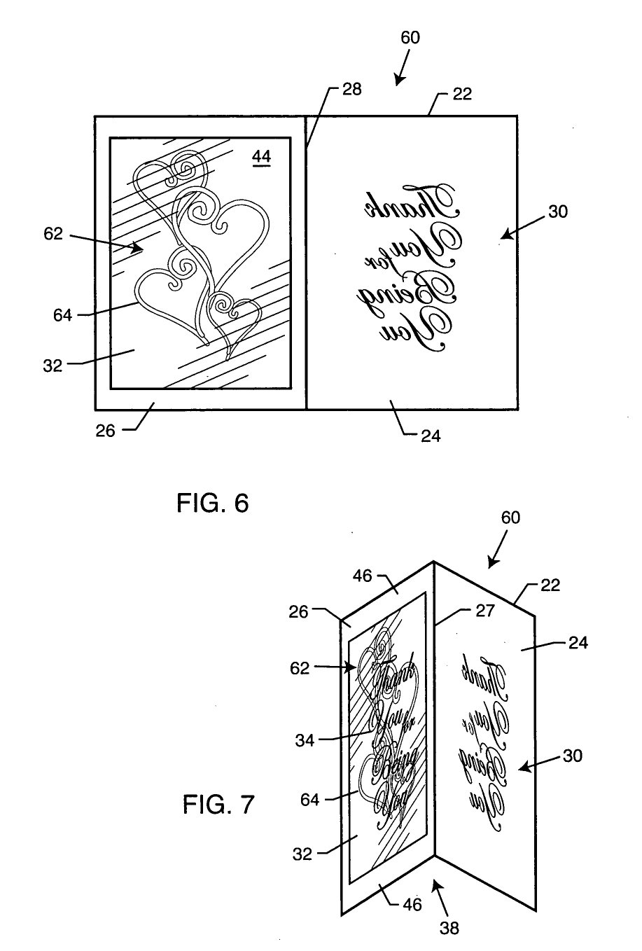

Another embodiment of a greeting card 60 of the present invention is shown in FIGS. 6 and 7 that is similar to cards 20, 50 except that the reflective foil sheet 32 has various adornments, embellishments and/or decorations 62 including, but not limited to, decorative etchings (not shown), graphical indicia 64 or the like. These adornments 62 may be formed on, disposed on or attached to the surface of the reflective foil sheet 32 by various conventional means. Although not illustrated, as outlined above, the border 46 surrounding the sheet 32 may includes various embellishments (not shown) such as graphical indicia, decorative etchings, ribbons, bows, printing or the like. As seen in FIG. 7, the graphical indicia 64 provides a background over which the reflection 34 of the mirror-image alpha-numeric indicia 30 appears in order to enhance the aesthetic look of the reflected indicia 34 when viewed by a user.

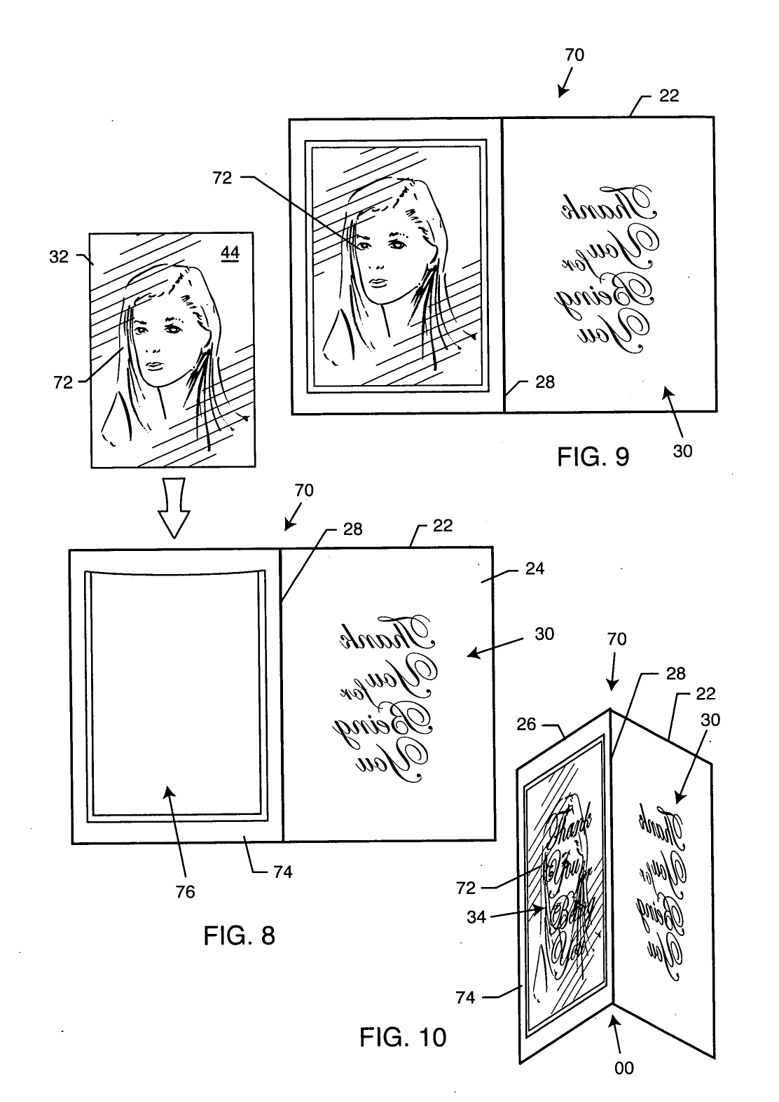

Still another greeting card 70 embodying the present invention is shown in FIGS. 8-10 that is similar to cards 20, 50, 60 except that the reflective foil sheet 32 includes an image 72 incorporated onto the surface 44 of the sheet 32. Likewise, various adornments, embellishments and/or decorations including, but not limited to, decorative etchings (not shown), graphical indicia (not shown) or the like may also appear on the sheet 32. The image 72 may be formed on, disposed on or attached to the surface of the reflective foil sheet 32 by various conventional means. Although not illustrated, the border 46 surrounding the sheet 32 may includes various embellishments (not shown) such as graphical indicia, decorative etchings, ribbons, bows, printing or the like. As seen in FIG. 10, the image 72 provides a background over which the reflection 34 of the mirror-image alpha-numeric indicia 30 appears in order to enhance the aesthetic look of the reflected indicia 34 when viewed by a user. The image 72 may be that of the person sending the card, a loved one, a deceased person being remembered in a sympathy card or the like.

The greeting card 70 includes a raised border 74 attached to the surface of the substrate 22 on the second half 26 of the second side 38 of the substrate 22 to define a pocket 76 within which the foil sheet 32 is held. The border 74 surrounds the foil sheet 32 when the sheet 32 is held within the pocket 76 and includes an aperture 76 through which the sheet 32 is viewed by the user. The foil sheet 32 is slid into the pocket 76 through an open slit (not shown) defined by the border 74 and the surface of the substrate 22.

Alternatively, the image 72 may be on a photograph or the like which is slid into the pocket 76. The aperture 76 is covered by a relatively transparent material that is reflective enough to allow a user to read the reflection 34 of the mirror-image alpha-numeric indicia 30 while still allowing the image 72 to be seen such that the image 72 forms the background behind the reflection 34. In a further alternative, the border 74 may be replaced by pocket 76 in which the foregoing photograph 72 is held may be formed solely by the foregoing material alone with one side of the pocket 76 attached to the substrate 22.

The above-described embodiments of the present invention are illustrative only and not limiting. It will thus be apparent to those skilled in the art that various changes and modifications may be made without departing from this invention in its broader aspects. Therefore, the appended claims encompass all such changes and modifications as falling within the true spirit and scope of this invention.

What is claimed is:

1. A greeting card, comprising:
a planar substrate divided generally into first and second halves by a fold disposed therebetween;
mirror-image alpha-numeric indicia disposed on the first half of the substrate; and
a reflective foil sheet disposed on the second half of the substrate;
wherein the alpha-numeric indicia is right-readable on the reflective foil sheet when at least one of the first and second halves of the substrate is pivoted along the fold.

2. The greeting card of claim 1, wherein the substrate includes a first side, a second side, and right-readable alpha-numeric indicia disposed on one of the first and second halves of the substrate on an opposite side of the substrate from the mirror-image alpha-numeric indicia.

3. The greeting card of claim 2, wherein the right-readable alpha-numeric indicia is defined against a colored background.

4. The greeting card of claim 1, including decorative etchings on a surface of the reflective foil sheet.

5. The greeting card of claim 1, including graphical indicia disposed on a surface of the reflective foil sheet.

6. The greeting card of claim 1, wherein the reflective foil sheet defines a border on the second half of the substrate.

7. The greeting card of claim 1, including a border surrounding the foil sheet.

8. The greeting card of claim 1, wherein the border defines a pocket within which the foil sheet is held.

9. The greeting card of claim 1, wherein the substrate comprises heavy bond paper.

10. The greeting card of claim 1, wherein the reflective foil sheet includes an image incorporated onto a surface of the sheet.

11. A greeting card, comprising:
a planar substrate divided generally into first and second halves by a fold disposed therebetween;
mirror-image alpha-numeric indicia disposed on the first half of the substrate and defined against a colored background; and
a reflective foil sheet disposed on the second half of the substrate and defining a border;
wherein the alpha-numeric indicia is right-readable on the reflective foil sheet when at least one of the first and second halves of the substrate is pivoted along the fold.

12. The greeting card of claim 11, wherein the substrate includes a first side, a second side, right-readable alpha-numeric indicia disposed on one of the first and second halves of the substrate on an opposite side of the substrate from the mirror-image alpha-numeric indicia.

13. The greeting card of claim 11, including decorative etchings on a surface of the reflective foil sheet.

14. The greeting card of claim 11, including graphical indicia disposed on a surface of the reflective foil sheet.

15. The greeting card of claim 11, including a border surrounding the foil sheet that defines a pocket within which the foil sheet is held.

16. The greeting card of claim 11, wherein the generally planar substrate comprises heavy bond paper.

17. The greeting card of claim 11, wherein the reflective foil sheet includes an image incorporated onto a surface thereof.

18. A greeting card, comprising:
a planar substrate including first and second sides, the substrate being made of heavy bond paper divided generally into first and second halves by a fold disposed therebetween;
mirror-image alpha-numeric indicia disposed on the first half of the substrate and defined against a colored background;
right-readable alpha-numeric indicia disposed on one of the first and second halves of the substrate on an opposite side of the substrate from the mirror-image alpha-numeric indicia, the right-readable alpha-numeric indicia being defined against a colored background; and
a reflective foil sheet attached to the second half of the substrate and defining a border on the second half of the substrate;
wherein the mirror-image alpha-numeric indicia is right-readable on the reflective foil sheet when at least one of the first and second halves of the substrate is pivoted along the fold.

19. The greeting card of claim 18, including decorative etchings on a surface of the reflective foil sheet, and graphical indicia disposed on a surface of the reflective foil sheet.

20. The greeting card of claim 18, including a border surrounding the foil sheet that defines a pocket within which the foil sheet is held, wherein the reflective foil sheet includes an image incorporated onto a surface of the sheet.
